(19) United States
(12) Patent Application Publication
(10) Pub. No.: US 2026/0142505 A1
(43) Pub. Date: May 21, 2026

(54) MAGNETIC POSITIONING MAGNET SHEET AND WIRELESS CHARGING MODULE

(71) Applicant: SHENZHEN YN TECH CO., LTD., Shenzhen (CN)

(72) Inventors: Leo Li, Shenzhen (CN); Kevin Li, Shenzhen (CN); Terrence Zeng, Shenzhen (CN); Jeff Zhang, Shenzhen (CN); Aimee Ru, Shenzhen (CN)

(21) Appl. No.: 19/450,774

(22) Filed: Jan. 16, 2026

Related U.S. Application Data
(63) Continuation of application No. PCT/CN2024/108716, filed on Jul. 31, 2024.

(30) Foreign Application Priority Data
Jun. 11, 2024 (CN) 202410745159.X

(51) Int. Cl. H02J 50/90; H01F 1/16; H01F 1/38; H02J 50/10; H02J 50/70

(52) U.S. Cl. CPC H02J 50/90; H01F 1/16; H01F 1/38; H02J 50/10; H02J 50/70

(57) ABSTRACT

The present disclosure provides a magnetic attraction positioning magnet sheet and a wireless charging module. The magnetic attraction positioning magnet sheet including a plurality of hard magnetic material sheets and a plurality of soft magnetic material sheets spaced apart and arranged in an alternating manner to form an annular positioning magnet sheet. The hard magnetic material sheet can be a magnet sheet (such as a samarium cobalt magnet sheet), the soft magnetic material sheet is at least one selected from an amorphous and/or nanocrystalline magnet sheet, a soft magnetic ferrite magnet sheet, and a soft magnetic alloy sheet. The magnetic attraction positioning magnet sheet can ensure the magnetic alignment between the receiving end and the transmitting end, while reducing or even completely avoiding the interference of the magnetic attraction positioning magnet sheet on the WPC coil, reducing losses, and improving charging efficiency.

### CROSS REFERENCE TO RELATED APPLICATIONS

The present application is a Continuation application of PCT Application No. PCT/CN2024/108716 filed on Jul. 31, 2024, which claims the benefit of Chinese Patent Application No. 202410745159.X filed on Jun. 11, 2024. All the above are hereby incorporated by reference in their entirety.

### FIELD

The present disclosure relates to the field of wireless charging technology, and more particularly, to a magnetic attraction positioning magnet sheet and a wireless charging module.

### BACKGROUND

Wireless charging has become a standard feature on current high-end flagship smartphones. The convenience of charging without plugging in cables and simply placing the smartphone to charge has made this feature increasingly popular among users. With the promotion of domestic mobile phone brands, the wireless charging speed can even reach up to 100 W, exceeding the wired charging speed of many mobile phones.

Currently, supporting products such as wireless power banks, wireless charging stands, and wireless car chargers are becoming increasingly diverse, and the ecosystem of mobile phone peripherals supporting wireless charging such as TWS Bluetooth earphones, smartwatches, and smart bracelets is also becoming more and more mature. There is no doubt that wireless charging technology will be further developed and popularized.

The main technical indicators for wireless charging of consumer electronics are threefold: charging power, efficiency, and heat generation (temperature rise). When people use wireless charging for consumer electronics, the misalignment of the consumer electronics may easily occur. At this point, the wireless charging efficiency and charging power significantly decrease, resulting in severe heat generation. This is because a large number of magnetic flux lines at a transmitting end cannot effectively pass through a coil at a receiving end due to the severe misalignment, resulting in low charging efficiency. Meanwhile, the misalignment causes a large number of magnetic flux lines to pass through a local area (off-center) of the coil, resulting in excessive or saturated magnetic field in the local area of the magnet sheet, a sharp increase in power loss, and a high temperature rise due to delayed heat dissipation.

The problem of low charging efficiency and severe heat generation due to severe misalignment can be solved by increasing a size and a thickness of a charging tray, adding a cooling fan, or reducing the charging power. However, these solutions require higher costs or longer charging time. A better solution is to ensure alignment and fundamentally avoid misalignments. Mobile phone manufacturers represented by Apple have launched magnetic wireless charging where annular magnets are placed at the transmitting end and the receiving end to ensure precise coil alignment through magnetic attraction. With the Wireless Power Consortium (WPC) officially releasing the new Qi 2.0 wireless charging standard in 2022, which incorporates Apple's MagSafe magnetic attachment protocol, magnetic attraction wireless charging will be further popularized.

However, the presence of magnet also introduces new problems. Firstly, an orientation of the magnet affects a saturation current of the coil module. When the magnetic field direction of the magnet is the same as that of the magnetic field generated by the coil, a false increase in the saturation current may occur. The saturation current is defined as an external bias current that reduces a coil inductance to a certain percentage. If the magnetic field generated by the external bias current is in the same direction as that of the magnetic field of the magnet, the magnetic flux lines of the nanocrystalline material are counteracted, resulting in an increase in the saturation current of the coil module (as shown in FIGS. 1 and 2). If the magnetic field generated by the external bias current is reverse to the magnetic field of the magnet, the nanocrystalline material is more prone to saturation, resulting in a decrease in the saturation current of the coil module (as shown in FIGS. 3 and 4). That is, the presence of magnet is equivalent to adding a constant bias current to the coil. Secondly, the magnets used for magnetic attraction are typically ferromagnetic alloys like NdFeB or Fe₃O₄, which, may easily cause eddy current losses under alternating magnetic fields. Therefore, the magnet should be kept at a sufficient distance from the coil. However, the space for wireless charging in consumer electronics is often limited, which makes the magnet and coil closer together. The magnet consumes some energy, reducing the efficiency of wireless charging. Therefore, the problems brought by the introduction of magnetic attraction wireless charging magnet need to be urgently addressed.

The Chinese patent CN202110665207.0 discloses a wireless charging magnetic positioning structure, including a first magnet and a second magnet. The first magnet and the second magnet are arranged at intervals around the wireless charging coil to form a ring shape. The magnetization directions of the first magnet and the second magnet are opposite. By alternately arranging the first magnet and the second magnet in opposite magnetization directions around the wireless charging coil to form a ring shape, the first magnet at the transmitting end and the first magnet at the receiving end, and the second magnet at the transmitting end and the second magnet at the receiving end form a closed loop of magnetic flux lines, thereby increasing the magnetic attraction between the transmitting end and the receiving end. The opposite magnetization directions of adjacent first and second magnets result in a greater magnetic attraction force generated by the magnets at the transmitting and receiving ends and have a smaller impact on the magnetic flux lines of the module. However, this structure requires a large number of magnetized small magnets and the assembly is more complex. Moreover, this structure requires a large gap between the magnet and a magnetic shielding sheet to reduce the interference of the closed loop magnetic flux lines formed between the first magnet and the second magnet on the magnetic flux of the wireless charging coil.

In our prior patent CN202310740011.2, by respectively setting a nanocrystalline layer of magnetic shielding strips perpendicular to a plane of the annular positioning magnet on an inner side and an outer side of the annular positioning magnet, the interference of the magnetic attraction positioning magnet on the coil can be shielded or reduced, thereby reducing losses and improving charging efficiency. However, the installation of magnetic shielding strips still increases the structure and assembly complexity of wireless charging modules to a certain extent.

### SUMMARY

The primary objective of the present disclosure is to provide a magnetic attraction positioning magnet sheet in response to the shortcomings and deficiencies of the existing technologies mentioned above. This magnetic attraction positioning magnet sheet can ensure the magnetic alignment between a receiving end and a transmitting end, while reducing or even completely avoiding the interference of the magnetic attraction positioning magnet sheet on a WPC coil, reducing losses, and improving charging efficiency. In addition, this solution has lower cost, more convenient structure and assembly, which is conducive to the promotion and popularization of magnetic attraction.

Another objective of the present disclosure is to provide a wireless charging module including the above-mentioned magnetic attraction positioning magnet sheet.

The purpose of the present disclosure is achieved through the following technical solutions:

A magnetic attraction positioning magnet sheet including a plurality of hard magnetic material sheets and a plurality of soft magnetic material sheets, wherein the hard magnetic material sheets and the soft magnetic material sheets are spaced apart and arranged in an alternating manner to form an annular positioning magnet sheet.

In some embodiments, the hard magnetic material sheet is a magnet sheet (such as a samarium cobalt magnet sheet, a neodymium iron boron magnet sheet, a ferrite magnet sheet, an aluminum nickel cobalt magnet sheet, and an iron chromium cobalt magnet sheet), the soft magnetic material sheet is at least one selected from an amorphous and/or nanocrystalline magnet sheet, a soft magnetic ferrite magnet sheet, and a soft magnetic alloy sheet.

In some embodiments, the positioning magnet sheet includes two or more hard magnetic material sheets and two or more soft magnetic material sheets, and the soft magnetic material sheets are symmetrically arranged about a center of the annular positioning magnet sheet. By symmetrically setting the soft magnetic material sheets to replace some hard magnetic material sheets, the interference of the magnets on a coil module is reduced and the loss is minimized.

In some embodiments, a vertical projection area of the soft magnetic material sheets accounts for 10% to 90% of a vertical projection area of the annular positioning magnet sheet. In the present disclosure, the hard magnetic material sheet has low magnetic permeability and high coercivity, and can maintain magnetism for a long time after magnetization, ensuring good magnetic attraction positioning ability. The soft magnetic material sheet has low coercivity and high magnetic permeability, which can be magnetized by an adjacent magnet sheet to generate a magnetic force, ensuring magnetic attraction positioning ability, and can attract the magnetic flux lines of the magnet sheet, reducing the interference of the magnet sheets on the WPC coil. Meanwhile, the high magnetic permeability characteristics of the soft magnetic material sheet result in lower hysteresis and eddy current losses. Through the above configurations, compared to the conventional annular magnetic positioning magnet sheets (as shown in FIG. 5), wireless charging efficiency of the magnetic attraction positioning magnet sheet of the present disclosure can be improved to a certain extent while ensuring good magnetic positioning ability.

In some embodiments, a thickness of each hard magnetic material sheet and a thickness of each soft magnetic material sheet respectively range from 0.2 to 1.0 mm, and the thickness of each hard magnetic material sheet is equal to that of each soft magnetic material sheet.

In some embodiments, the soft magnetic material sheet is an amorphous and/or nanocrystalline magnet sheet.

In some embodiments, the amorphous and/or nanocrystalline magnet sheet is formed by multiple layers of amorphous and/or nanocrystalline material compounded by double-sided adhesive film or bonding resin. The amorphous and/or nanocrystalline magnet sheet can be obtained by punching and cutting multi-layer amorphous and/or nanocrystalline strip material formed by double-sided adhesive bonding or resin immersion curing.

In some embodiments, a thickness of a single layer of the amorphous and/or nanocrystalline material ranges from 5 to 35 μm.

In some embodiments, the layer of amorphous and/or nanocrystalline material is made of amorphous and/or nanocrystalline material with a composition system of FeSiB, FeSiBC, FeCoSiBPC, FeCuNbSiB, FeCuMoSiB, and FeSiBPCu.

In some embodiments, a relative magnetic permeability of the amorphous and/or nanocrystalline magnet sheet ranges from 100 to 10000. A low magnetic permeability may result in insufficient magnetic attraction of the magnet sheet and thus reduce the effectiveness of improvement, while a high magnetic permeability may result in easy attraction of the magnetic field of the WPC coil and thus cause losses.

In some embodiments, a layer of annular amorphous and/or nanocrystalline magnetic shielding sheet is further arranged below the annular positioning magnet sheet to support and shield a magnetic field.

In some embodiments, a thickness of the annular amorphous and/or nanocrystalline magnetic shielding sheet ranges from 0.02 to 0.1 mm, and a width of the annular amorphous and/or nanocrystalline magnetic shielding sheet is greater than that of the annular positioning magnet sheet by 0 to 0.5 mm.

A wireless charging module having the above-mentioned magnetic attraction positioning magnet sheet, including a magnetic shielding sheet, a coil arranged on the magnetic shielding sheet, and the magnetic attraction positioning magnet sheet, wherein the magnetic attraction positioning magnet sheet is arranged around a periphery of the magnetic shielding sheet and the coil.

Compared with the existing technology, the beneficial effects of the present disclosure are:

Firstly, compared with the existing annular magnet positioning magnet sheets, by replacing the magnet sheet with soft magnetic material sheet with low coercivity and high permeability, adjacent magnet sheets of the present disclosure can be magnetized to generate a magnetic force, which ensures magnetic attraction positioning ability and attracts the magnetic flux lines of the magnet sheet, and thus reduces the interference of the magnet sheet on the WPC coil. Meanwhile, the high permeability characteristics of the soft magnetic material sheet result in lower hysteresis loss and eddy current loss, which can reduce losses and improve wireless charging efficiency while ensuring good magnetic attraction positioning ability.

Secondly, the soft magnetic material used in the positioning magnet sheet of the present disclosure does not require magnetization, and the annular positioning magnet sheet can be formed requiring less small magnet sheets, facilitating the assembly.

Thirdly, since fewer hard magnetic materials are required, the compatibility of the receiving end is improved, thus, foreign objects can be more easily identified and detected before the wireless charging, regardless of whether the transmitting end has magnetic attraction function or not.

### BRIEF DESCRIPTION OF THE DRAWINGS

FIGS. 1 and 2 are schematic diagrams showing a distribution of magnetic induction lines in a situation where a magnetic field generated by an external bias current is in the same direction as that of a magnetic field generated by the magnetic wireless charging module.

FIGS. 3 and 4 are schematic diagrams showing a distribution of magnetic induction lines in a situation where a magnetic field generated by the external bias current is reverse to the magnetic field generated by the magnetic wireless charging module.

FIG. 5 is a schematic view of an existing annular magnetic positioning magnet sheet.

FIG. 6 is a schematic view of a magnetic attraction positioning magnet sheet according to Embodiment 1 of the present disclosure.

FIG. 7 is a schematic view a magnetic attraction positioning magnet sheet according to Embodiment 2 of the present disclosure.

FIG. 8 is a schematic view a magnetic attraction positioning magnet sheet according to Embodiment 3 of the present disclosure.

FIGS. 9 and 10 are respectively a schematic view showing an overall structure of a magnetic wireless charging module and a A-sectional view of the magnetic wireless charging module according to Embodiment 5 of the present disclosure.

FIG. 11 is a schematic view of a magnetic positioning magnet according to Comparative Embodiment 2 of the present disclosure.

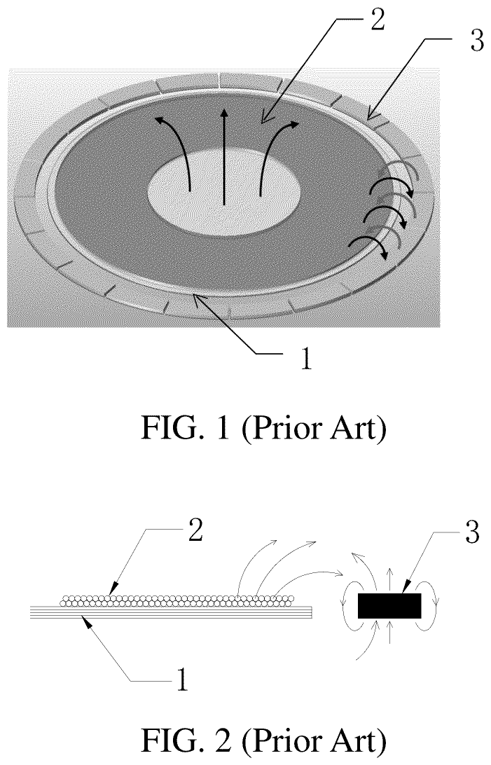

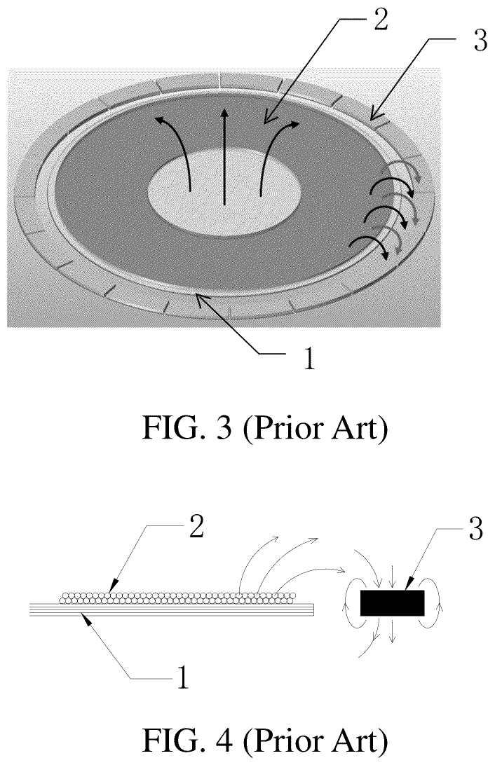

### DETAILED DESCRIPTION

The present disclosure will be further described in detail with reference to the embodiments and accompanying drawings, but the embodiments of the present disclosure are not limited to these.

### Embodiment 1

As shown in FIG. 6, a magnetic attraction positioning magnet sheet is provided, including a plurality of neodymium iron boron magnet sheets 3-1 and a plurality of FeCuNbSiB nanocrystalline sheets 3-2. The magnet sheets 3-1 and the nanocrystalline sheets 3-2 are spaced apart and arranged in an alternating manner to form an annular positioning magnet sheet. A thickness of each magnet sheet 3-1 and a thickness of each nanocrystalline sheet 3-2 are respectively 0.3 mm, and a size of each magnet sheet 3-1 is the same as that of each nanocrystalline sheet 3-2.

The nanocrystalline sheet is prepared by the following method:

Selecting a nanocrystalline strip material with a thickness of a single layer being 18-20 μm; forming a first adhesive layer on an upper surface of a top layer of the nanocrystalline strip material, a second adhesive layer on a lower surface of a bottom layer of the nanocrystalline strip material, and a third adhesive layer between adjacent nanocrystalline strip materials to form a magnetic single-layered structure containing two layers of nanocrystalline; performing fragmentation treatment to allow an initial magnetic permeability to be 1000 at a test frequency of 100 kHz based on the total thickness of the nanocrystalline; stacking the magnetic single layered structure multiple times to obtain a magnetic composite layered structure with a total thickness of about 0.3 mm; and cutting the magnetic composite layered structure into a designed shape and combining the magnetic composite layered structure in designed shape with small magnet sheets.

### Embodiment 2

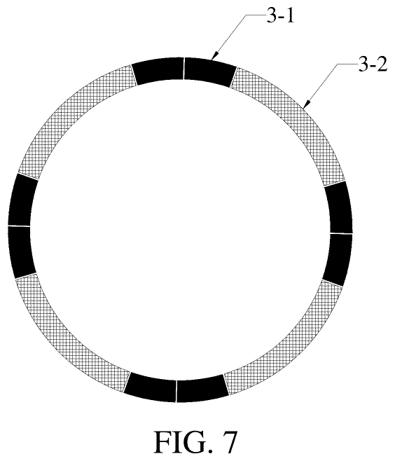

As shown in FIG. 7, a magnetic attraction positioning magnet sheet according to Embodiment 2 is provided, including a plurality of samarium cobalt magnet sheets 3-1 and a plurality of FeCuNbSiB nanocrystalline sheets 3-2. The magnet sheets 3-1 and the nanocrystalline sheets 3-2 are spaced apart and arranged in an alternating manner to form an annular positioning magnet sheet. A thickness of each magnet sheet 3-1 and a thickness of each nanocrystalline sheet 3-2 are respectively 0.4 mm, and a size of each nanocrystalline sheet 3-2 is the same as a total size of two magnet sheets 3-1. The magnet sheets 3-1 and the nanocrystalline sheets 3-2 are arranged in repeating units. Each unit includes two of the magnet sheets 3-1 and one of the nanocrystalline sheets 3-2 arranged in order. These units are connected end-to-end to form the annular positioning magnet sheet.

### Embodiment 3

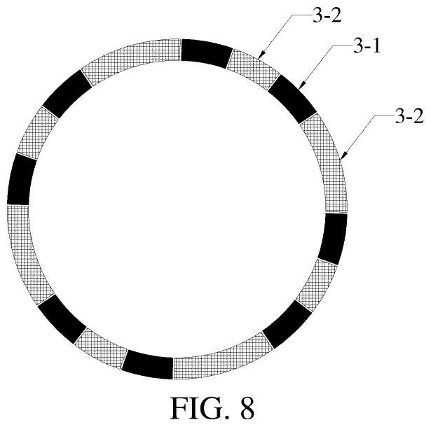

As shown in FIG. 8, a magnetic attraction positioning magnet sheet according to Embodiment 3 is provided, including a plurality of neodymium iron boron magnet sheets 3-1 and a plurality of FeSiB nanocrystalline sheets 3-2. The magnet sheets 3-1 and the nanocrystalline sheets 3-2 are spaced apart and arranged in an alternating manner to form a annular positioning magnet sheet. A thickness of each magnet sheet 3-1 and a thickness of each nanocrystalline sheet 3-2 are respectively 0.5 mm. Each nanocrystalline sheet 3-2 is formed by nanocrystalline sheets of different sizes, including a large one having the same size as a total size of the two magnet sheets and a small one having the same size as a size of one magnet sheet. The magnet sheets 3-1 and the nanocrystalline sheets 3-2 are arranged in repeating units. Each unit includes one of the magnet sheets, one of the small nanocrystalline sheets, one of the magnet sheets, and one of the large nanocrystalline sheets arranged in order. These units are connected end-to-end to form the annular positioning magnet sheet.

### Embodiment 4

Based on Embodiment 1, a magnetic attraction positioning magnet sheet according to Embodiment 4 further includes a layer of annular nanocrystalline magnetic shielding sheet arranged below the annular positioning magnet sheet to support and shield a magnetic field. The annular nanocrystalline magnetic shielding sheet has a thickness of 0.05 mm, and a width greater than that of the annular positioning magnet sheet by 0.2 mm.

### Embodiment 5

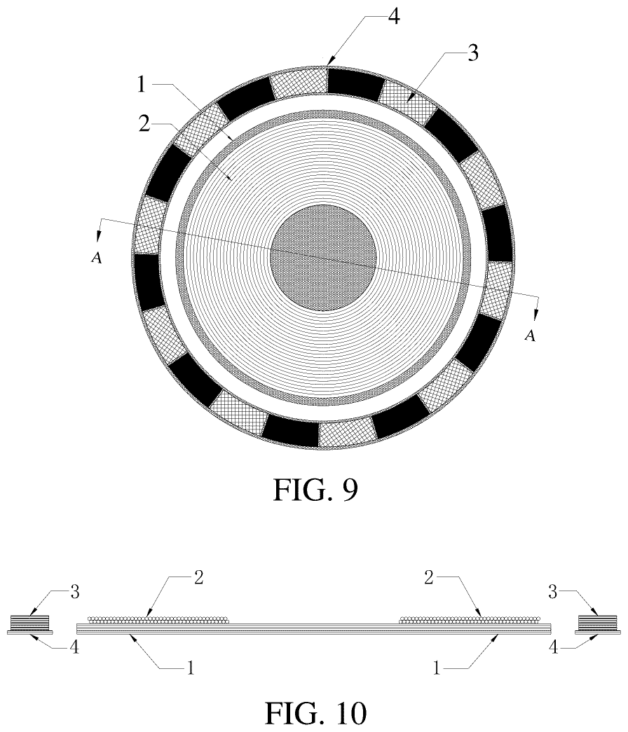

As shown in FIGS. 9 and 10, a magnetic wireless charging module is provided, including a magnetic shielding sheet 1, a coil 2 arranged on the magnetic shielding sheet, and a magnetic attraction positioning sheet. The magnetic attraction positioning sheet surrounds a periphery of the magnetic shielding sheet 1 and the coil 2. The magnetic attraction positioning magnet sheet adopts the magnetic attraction positioning magnet sheet of Embodiment 4, which includes an annular positioning magnet sheet 3 and a nanocrystalline magnetic shielding sheet 4 arranged below the annular positioning magnet sheet 3.

### Comparative Embodiment 1

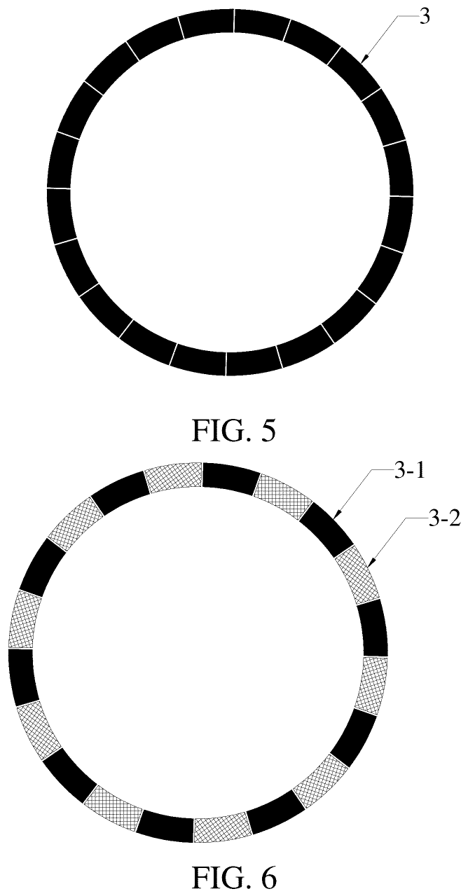

Compared with Embodiment 1, in the magnetic attraction positioning magnet sheet of Comparative Embodiment 1, the annular positioning magnet sheet is placed with an existing annular magnetic positioning magnet sheet (as shown in the schematic view of FIG. 5), with the rest being the same.

### Comparative Embodiment 2

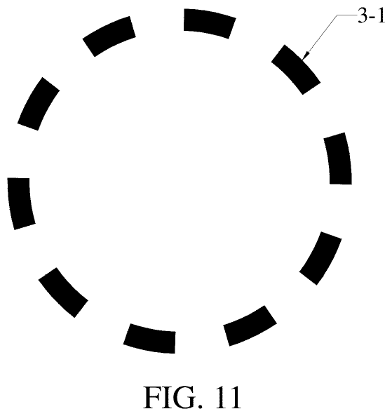

Compared with Embodiment 2, as shown in FIG. 11, in the magnetic attraction positioning magnet sheet of Comparative Embodiment 2, the nanocrystalline sheets in the annular positioning magnet sheet are omitted, leaving only a part of the magnet sheet 3-1.

The comparison of the testing effects of different embodiments is shown in Table 1. After some magnet sheets are replaced with amorphous nanocrystalline material, a magnitude of the alignment magnetic attraction force and the maximum horizontal correction displacement are similar to those of Comparative Embodiment 1, and a charging efficiency η remains unchanged or is slightly improved, indicating that replacing some magnet sheets with amorphous nanocrystalline material is feasible in terms of functionality. Comparing the assembly efficiency and cost, Embodiments 1˜4 have significant advantages.

TABLE 1
Comparison of Testing Effects of Different Embodiments

| | performance | | | | |
|---|---|---|---|---|---|
| | | Maximum | | | |
| | Alignment | horizontal | | | Material |
| | magnetic | correction | Charging | | and |
| | attraction | displacement | efficiency | Assembly | assembly |
| Embodiment | force * (N) | * * (mm) | η*** | efficiency | costs |
| Embodiment 1 | 7.4 | 4.2 | 84.9% | 150% | 80% |
| Embodiment 2 | 7.0 | 3.8 | 84.7% | 165% | 85% |
| Embodiment 3 | 7.6 | 3.9 | 84.7% | 155% | 76% |
| Embodiment 4 | 7.5 | 4.2 | 85.0% | 145% | 82% |
| Comparative | 7.5 | 4.5 | 84.6% | 100% | 100% |
| Embodiment 1 | | | | | |
| Comparative | 3.9 | 3.8 | 84.8% | 180% | 58% |
| Embodiment 2 | | | | | |

The transmitting end in the above test is a mainstream magnetic wireless charger in the market, and the receiving end is a charging module from a certain iPhone model supporting magnetic wireless charging and its improved version with the magnet from the present embodiment.
* Alignment magnetic attraction force: This is defined as, after the magnets at the transmitting end and the receiving end are aligned, the minimum force required to vertically separate the magnets at the transmitting end and the receiving end along a central axis of the annular magnet sheet. The greater the minimum force, the stronger the alignment magnetic attraction force.
* * Maximum horizontal correction displacement: This is defined as, after the magnets at the transmitting end and the receiving end are aligned, the smallest horizontal displacement of the transmitting end (weighing about 100 g) perpendicular to the center axis of the annular magnet sheet from which the transmitting end can no longer reset after the movement. The greater the smallest horizontal displacement, the stronger the magnetic attraction alignment correction ability.
***Charging efficiency η: η = receiving end power/transmitting end power * 100%. The greater the η, the smaller the charging loss.

The above embodiments are preferred embodiments of the present disclosure, but the embodiments of the present disclosure are not limited by the above embodiments. Any other changes, modifications, substitutions, combinations, or simplifications made without departing from the spirit and principles of the present disclosure should be equivalent substitution methods and are included in the scope of protection of the present disclosure.

What is claimed is:

1. A magnetic attraction positioning magnet sheet, comprising a plurality of hard magnetic material sheets and a plurality of soft magnetic material sheets, wherein the hard magnetic material sheets and the soft magnetic material sheets are spaced apart and arranged in an alternating manner to form an annular positioning magnet sheet.

2. The magnetic attraction positioning magnet sheet according to claim 1, wherein the hard magnetic material sheet is a magnet sheet, the soft magnetic material sheet is at least one selected from an amorphous sheet, a nanocrystalline magnet sheet, a soft magnetic ferrite magnet sheet, and a soft magnetic alloy sheet.

3. The magnetic attraction positioning magnet sheet according to claim 1, wherein the annular positioning magnet sheet comprises two or more hard magnetic material sheets and two or more soft magnetic material sheets, and the soft magnetic material sheets are symmetrically arranged about a center of the annular positioning magnet sheet.

4. The magnetic attraction positioning magnet sheet according to claim 1, wherein a vertical projection area of the soft magnetic material sheets accounts for 10% to 90% of a vertical projection area of the annular positioning magnet sheet.

5. The magnetic attraction positioning magnet sheet according to claim 1, wherein a thickness of each hard magnetic material sheet and a thickness of each soft magnetic material sheet respectively range from 0.2 to 1.0 mm, and the thickness of each hard magnetic material sheet is equal to that of each soft magnetic material sheet.

6. The magnetic attraction positioning magnet sheet according to claim 1, wherein the soft magnetic material sheet is an amorphous and/or nanocrystalline magnet sheet.

7. The magnetic attraction positioning magnet sheet according to claim 6, wherein the amorphous and/or nanocrystalline magnet sheet is formed by multiple layers of amorphous and/or nanocrystalline material compounded by double-sided adhesive film or bonding resin.

8. The magnetic attraction positioning magnet sheet according to claim 7, wherein a thickness of a single layer of the amorphous and/or nanocrystalline material ranges from 5 to 35 μm.

9. The magnetic attraction positioning magnet sheet according to claim 7, wherein the layer of the amorphous and/or nanocrystalline material is formed by amorphous and/or nanocrystalline materials with a composition system of FeSiB, FeSiBC, FeCoSiBPC, FeCuNbSiB, FeCuMoSiB, FeSiBPCu.

10. The magnetic attraction positioning magnet sheet according to claim 6, wherein a relative magnetic permeability of the amorphous and/or nanocrystalline magnet sheet ranges from 10 to 10000.

11. The magnetic attraction positioning magnet sheet according to claim 1, wherein a layer of annular amorphous and/or nanocrystalline magnetic shielding sheet is further arranged below the annular positioning magnet sheet to support and shield a magnetic field.

12. The magnetic attraction positioning magnet sheet according to claim 11, wherein a thickness of the annular amorphous and/or nanocrystalline magnetic shielding sheet ranges from 0.02 to 0.1 mm, and a width of the annular amorphous and/or nanocrystalline magnetic shielding sheet is greater than that of the annular positioning magnet sheet by 0 to 0.5 mm.

13. A wireless charging module comprising the magnetic attraction positioning magnet sheet according to claim 1, wherein the wireless charging module comprises a magnetic shielding sheet, a coil arranged on the magnetic shielding sheet, and the magnetic attraction positioning magnet sheet arranged around a periphery of the magnetic shielding sheet and the coil.

14. A wireless charging module comprising the magnetic attraction positioning magnet sheet according to claim 2, wherein the wireless charging module comprises a magnetic shielding sheet, a coil arranged on the magnetic shielding sheet, and the magnetic attraction positioning magnet sheet arranged around a periphery of the magnetic shielding sheet and the coil.

15. A wireless charging module comprising the magnetic attraction positioning magnet sheet according claim 3, wherein the wireless charging module comprises a magnetic shielding sheet, a coil arranged on the magnetic shielding sheet, and the magnetic attraction positioning magnet sheet arranged around a periphery of the magnetic shielding sheet and the coil.

16. A wireless charging module comprising the magnetic attraction positioning magnet sheet according to claim 4, wherein the wireless charging module comprises a magnetic shielding sheet, a coil arranged on the magnetic shielding sheet, and the magnetic attraction positioning magnet sheet arranged around a periphery of the magnetic shielding sheet and the coil.

17. A wireless charging module comprising the magnetic attraction positioning magnet sheet according to claim 5, wherein the wireless charging module comprises a magnetic shielding sheet, a coil arranged on the magnetic shielding sheet, and the magnetic attraction positioning magnet sheet arranged around a periphery of the magnetic shielding sheet and the coil.

18. A wireless charging module comprising the magnetic attraction positioning magnet sheet according to claim 6, wherein the wireless charging module comprises a magnetic shielding sheet, a coil arranged on the magnetic shielding sheet, and the magnetic attraction positioning magnet sheet arranged around a periphery of the magnetic shielding sheet and the coil.

19. A wireless charging module comprising the magnetic attraction positioning magnet sheet according to claim 7, wherein the wireless charging module comprises a magnetic shielding sheet, a coil arranged on the magnetic shielding sheet, and the magnetic attraction positioning magnet sheet arranged around a periphery of the magnetic shielding sheet and the coil.

20. A wireless charging module comprising the magnetic attraction positioning magnet sheet according to claim 8, wherein the wireless charging module comprises a magnetic shielding sheet, a coil arranged on the magnetic shielding sheet, and the magnetic attraction positioning magnet sheet arranged around a periphery of the magnetic shielding sheet and the coil.
